(19) United States
(12) Patent Application Publication
(10) Pub. No.: US 2010/0017050 A1
(43) Pub. Date: Jan. 21, 2010

(54) APPARATUS AND METHOD FOR DETERMINING AND INDICATING DISTANCE BETWEEN FLARING AIRPLANE & LANDING SURFACE

(76) Inventor: Randy WATTS, Lone Jack, MO (US)

Correspondence Address: SPENCER, FANE, BRITT & BROWNE, 1000 WALNUT STREET, SUITE 1400, KANSAS CITY, MO, 64106-2140, US

(21) Appl. No.: 12/175,647

(22) Filed: Jul. 18, 2008

(51) Int. Cl. G06F 19/00

(52) U.S. Cl. 701/16

(57) ABSTRACT

An apparatus and method for determining and indicating a distance between a landing small airplane and a landing surface, wherein the distance is no more than approximately twenty-five feet. The apparatus emits signals from opposite sides of the airplane toward the landing surface, receives the signals reflected by the landing surface, and, based on the differences in time between emitting and receiving the signals, determines the distances from the opposite sides of the airplane to the landing surface. The apparatus is further operable to communicate the shorter distance to the pilot so that he can decide when to perform a flare maneuver.

### RELATED APPLICATIONS

The present U.S. non-provisional patent application is related to and claims priority benefit of both a first earlier-filed provisional patent application, Ser. No. 60/952,019, filed Jul. 26, 2007, and a second earlier-filed provisional patent application Ser. No. 60/968,953, filed Aug. 30, 2007. The identified earlier-filed applications are hereby incorporated by reference into the present application as though fully set forth herein.

### FIELD OF THE INVENTION

The present invention relates to apparatuses and methods for determining and indicating relatively small distances between airplanes and landing surfaces. More specifically, the present invention concerns an apparatus and method for determining the distances from opposite sides of the airplane to the landing surface, and communicating the shorter distance to the pilot so that he can decide when to perform a flare maneuver, wherein the distance is no more than approximately twenty-five feet.

### BACKGROUND OF THE INVENTION

A landing airplane typically performs a flare maneuver in order to more rapidly reduce its speed. This maneuver is performed approximately between one and three feet above the ground. It can be very difficult to judge this distance, especially at night, in fog or rain, or on an unfamiliar runway. When the maneuver is performed at a higher distance above the ground, i.e., if the pilot underestimates the height, the airplane may stall and/or experience significant impact when it contacts the runway, possibly resulting in damage to the airplane's landing gear and other airframe structures. If the pilot overestimates the height, the airplane may fly into the runway. Unfortunately, airplanes, particularly relatively small airplanes, are generally provided only with relatively imprecise pressure-based altimeters suitable for indicating tens or hundreds of feet of altitude but not the relatively small distances encountered during flare maneuvers. In such cases, the pilot must rely only on his or her peripheral vision and sense of distance.

Learning to land an airplane, including performing the flare maneuver, can cause a great deal of frustration in student pilots and result in additional money spent on extra practice time. By one estimate, approximately 60% of student pilots quit because of problems mastering landing maneuvers.

As such, a long-felt need exists for an apparatus and method for accurately determining and indicating such relatively small distances, and thereby avoiding damage and risk of damage to the airplane.

### SUMMARY OF THE INVENTION

The present invention overcomes the above-described and other problems and limitations in the prior art by providing an apparatus and method for determining and indicating a distance between a landing airplane and a landing surface, wherein the distance is no more than approximately twenty-five feet.

In one embodiment, the apparatus broadly comprises a first device attached to a first side of the airplane and associated with a first landing wheel (or ski or float), the first device including a first emitter operable to emit a first signal toward the landing surface, and a first receiver operable to detect the first signal reflected by the landing surface; a second device attached to a second side of the airplane and associated with a second landing wheel (or ski or float), the second device including a second emitter operable to emit a second signal toward the landing surface, and a second receiver operable to detect the second signal reflected by the landing surface; one or more microcontrollers operable to determine a first distance between the first device and the landing surface based on a first time between emission and reception of the first signal, to determine a second distance between the second device and the landing surface based on a second time between emission and reception of the second signal, and to compare the first distance to the second distance to determine a shorter distance; and a distance indicator operable to communicate the determined shorter distance to a pilot of the airplane.

In various implementations, the apparatus may further include any one or more of the following features. Each of the first and second devices may be attached to a respective landing strut. Each of the first and second devices may be attached to a respective wing. The first device may be removably attached to the first side of the airplane, and the second device may be removably attached to the second side of the airplane. The signals emitted by the first and second devices may be of a type selected from the group consisting of: pulse radar, ultrasonic, infrared, and laser. The distance indicator may be operable to communicate the distance visually or audibly. The apparatus may further include a flare indicator operable to indicate, based on the shorter distance, when the pilot should execute a flare maneuver. The one or more microcontrollers may be further operable to, if the second device is inoperable, determine the second distance as a function of the first distance, a known spacing between the first and second devices, and a known angular orientation of the airplane.

In another such feature, where the first and second landing wheels are moveable between a raised position and a lowered position, the apparatus may further include a third device attached to an underside of the airplane at a location such that when the first and second landing wheels are raised, the third device is lower than the first and second devices and when the landing gear is lowered, the third device is higher than the first and second devices, the third device including a third emitter operable to emit a third signal toward the landing surface, and a third receiver operable to detect the third signal reflected by the landing surface, the one or more microcontrollers being operable to determine a third distance between the third device and the landing surface based on a third time between emission and reception of the third signal, and to the first, second, and third distances to determine the shorter distance, and a landing gear indicator operable, when the third distance is the shorter distance, to alert the pilot that the first and second landing wheels are in the raised position.

The present invention may also be characterized as a method for determining and indicating a distance between a landing airplane and a landing surface, wherein the distance is no more than approximately twenty-five feet. In one embodiment, the method comprises the steps of emitting a first signal from a first side of the airplane toward the landing surface, and receiving the first signal reflected by the landing surface; emitting a second signal from a second side of the airplane toward the landing surface, and receiving the second signal reflected by the landing surface; determining a first distance between the first side of the airplane and the landing surface based on a first time between emission and reception of the first signal; determining a second distance between the second side of the airplane and the landing surface based on a second time between emission and reception of the second signal; comparing the first distance and the second distance to determine a shorter distance; and communicating the determined shorter distance to a pilot of the airplane. The method may further include the step of indicating, based on the shorter distance, when the pilot should execute a flare maneuver.

These and other features of the present invention are further discussed below in the section titled DETAILED DESCRIPTION OF THE INVENTION.

### BRIEF DESCRIPTION OF THE DRAWING FIGURES

The present invention is described herein with reference to the following drawing figures, which are not necessarily to scale:

FIG. 1 is a block diagram of components of an embodiment of the apparatus of the present invention;

FIG. 2 is a front elevation view of an airplane incorporating a first embodiment of the present invention;

FIG. 3 is a fragmentary front elevation view of an airplane illustrating a trigonometric relationship; and

FIG. 4 is a front elevation view of an airplane with retractable landing gear incorporating a second embodiment of the present invention.

### DETAILED DESCRIPTION OF INVENTION

With reference to the drawing figures, an apparatus 10 and method are herein described, shown, and otherwise disclosed in accordance with various embodiments, including a preferred embodiment, of the present invention. Broadly, the present invention allows for determining the distances from opposite sides of the airplane to the landing surface, and communicating the shorter distance to the pilot so that he can decide when to perform a flare maneuver, wherein the distance is no more than approximately twenty-five feet to allow the pilot time to consider when best to perform the flare maneuver. In various implementations, the distance may be no more than approximately ten feet or no more than approximately four feet. The apparatus 10 may be referred to as a “DAR” (“distance above runway”) sensor.

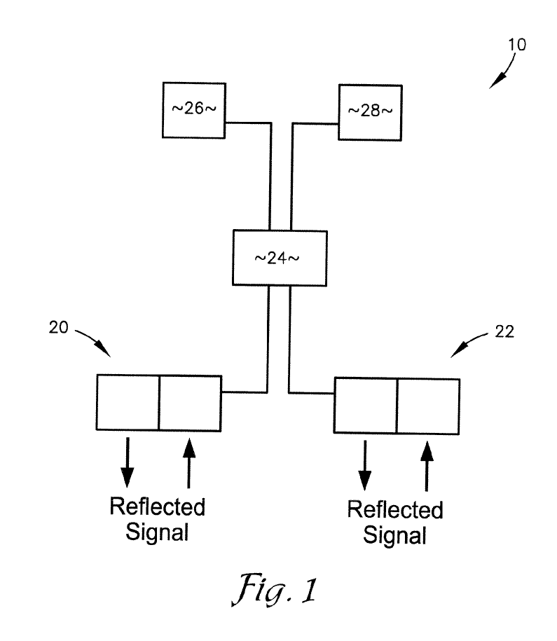

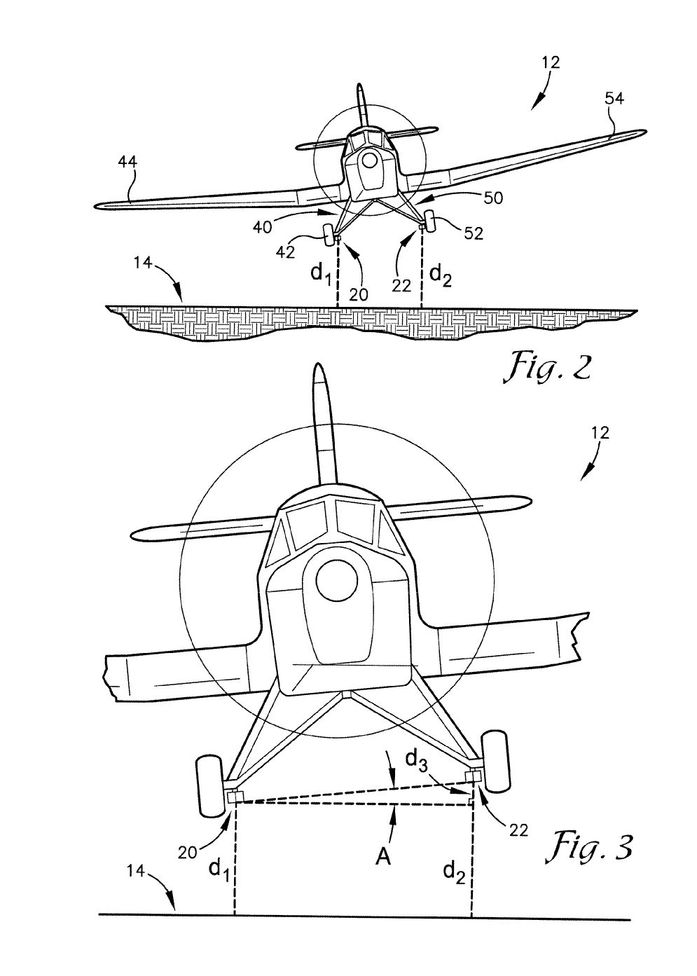

Referring to FIGS. 1 and 2, in a first embodiment the apparatus 10 broadly comprises a first emitter/receiver device 20; a second emitter/receiver device 22; a microcontroller 24; a visual distance indicator 26; and an audible distance indicator 28.

The emitter/receiver devices 20,22 are each operable to emit a signal for reflection off of the landing surface 14, and to then receive, or sense, the reflected signal. Signals corresponding to the times of emission and reception may also be sent to the microcontroller 24 for processing, as discussed below. Each emitter/receiver device 20,22 may emit any suitable type of signal, such as, for example, pulse radar, ultrasonic, infrared, or laser. Slower signals, such as, for example, sound-based signals may require appropriate adaptations, such as, for example, positioning the receiver behind the emitter in order to allow for forward movement of the airplane between emission and reception; however, the relatively low speeds and small distances encountered during flare maneuvers should require relatively little such compensation.

In one implementation, the emitter/receiver devices 20,22 may be based on technology similar to that currently used in wheeled vehicles to provide an indication of distance during backing operations.

The first emitter/receiver device 20 is positioned on a first side of the airplane 12, such as on a first landing strut 40 associated with a first wheel 42, ski, or float or on a first wing 44, and the second emitter/receiver device 22 is positioned on a second side of the airplane 12, such as on a second landing strut 50 associated with a second wheel 52, ski, or float or on a second wing 54. In the prior art, typically only one emitter/receiver device is mounted at a point on a longitudinal centerline of the airplane. However, in situations in which the airplane is not perfectly level, i.e., during common “cross-wind” landings, such a point is not indicative of the actual distance between the lower wheel, i.e., the wheel which will contact the landing surface first, and the higher wheel. Given the relatively small distances encountered during the flare maneuver, the discrepancy between the distance measured by the prior art and the actual distance between the lower wheel and the landing surface can be very significant. Thus, in the present invention, the first emitter/receiver 20 provides a first signal indicative of the distance, d1, between the first wheel 42 and the landing surface 14, and the second emitter/receiver 22 provides a second signal indicative of the distance, d2, between the second wheel 52 and the landing surface 14.

The microcontroller 24 is operable to receive signals regarding emission and reception from the first and second emitter/sensor devices 20,22, and, based thereon, to determine which distance, d1 or d2, is greater. The microcontroller 24 then sends corresponding signals to the visual and audible distance indicators 26,28 to communicate the lesser of the two distances to the pilot of the airplane 12.

To be clear, the distance between each device 20,22 and the landing surface can be calculated based on the time between emission and reception of the respective signal. In one implementation, each device 20,22 may include its own microcontroller for calculating this distance; while in another implementation a single microcontroller 24 may calculate both distances.

It will be appreciated that the devices 20,22 will not be located on the bottoms of the wheels 42,52, and, as such, the distance between each device 20,22 and the landing surface is indicative of but not identical to the distance between the bottoms of the wheels 42,52. To compensate for this difference, the devices 20,22 or the microcontroller 24 may be operable to add to each distance determination a fixed distance corresponding to the difference in distance between the device 20,22 and the bottom of the respective wheel 42,52.

The visual distance indicator 26 is operable to visually communicate an indication of the distance to the pilot. This may be accomplished by displaying numbers corresponding to the distance in a standard unit of measurement, or by displaying an illustrative representation of the distance, such as, for example, a number of bars or other symbols, each representing a standard unit of measurement, corresponding to the distance, or by displaying a flashing light, wherein the frequency or brightness of the flashing corresponds to the distance. The visual distance indicator 26 is preferably mounted or otherwise adapted to minimize the distance that the pilot must shift his or her eyes from the landing surface in order to see the distance.

In one embodiment, the visual indicator 26 makes use of animation or other realistic or semi-realistic representation of the airplane 12, or some relevant portion thereof, and the landing surface 14. In another embodiment, the visual indicator 26 is incorporated into a multi-purpose visual indicator, e.g., LCD screen, operable to communicate both the indication of the distance and a variety of other useful information.

The audible distance indicator 28 is operable to audibly communicate an indication of the distance to the pilot. This may be accomplished by voicing numbers corresponding to the distance in a standard unit of measurement, or by producing bursts of sound, wherein the frequency or volume of the bursts corresponds to the distance. The audible distance indicator 28 advantageously provides an indication of the distance when, given the landing conditions, the pilot cannot shift his or her eyes from the landing surface in order to see the visual distance indicator 26.

In one implementation, the visual and/or audible indicators 26,28 may indicate the distance at which the pilot should flare the airplane. It will be appreciated that this distance may vary depending on the design and weight of the airplane, design of the runway, and weather and/or other conditions associated with the landing. As such, the distance at which the indicators 26,28 indicate to flare may be adjustable to account for these or other factors.

In exemplary operation, the apparatus 10 may function substantially as follows. As the airplane 12 is approaching the point of performing the flare maneuver, each of the first and second emitter/receiver devices 20,22 begin emitting signals for reflection off the landing surface beneath their respective locations, and receiving the reflected signals. For each such emission/reception cycle, each device 20,22 provides a corresponding signal to the microcontroller 24 indicative of the time period between emission and reception of the reflected signal. Based on these signals, the microcontroller 24 determines which of the devices 20,22, and therefore which wheel 42,52, is closer to the landing surface 14, and provides corresponding signals to the visual and audible distance indicators 26,28. The visual and audible distance indicators 26,28 then communicate the distance to the pilot so that, at the appropriate time, he or she can perform the flare maneuver at the proper distance from the landing surface 14.

In one embodiment, the microcontroller 24 is further operable to function as follows. If one of the devices 20,22 is inoperable, or if only one of the devices is provided on the airplane, the microcontroller 24 receives the above-discussed signal from the single operable/present device 20,22, receives another signal corresponding to an angular orientation of the airplane 12, and, using a trigonometric relation, calculates the distance between the opposite side of the airplane 12 and the landing surface 14, and then determines which of the actual or calculated distances is closer to the landing surface 14, and provides corresponding signals to the visual and audible distance indicators 26,28. The angular orientation of the airplane can be provided by or derived from an existing “horizon” instrument. Referring also to FIG. 3, the trigonometric relation used to determine d3 may be: d3=(sine A)(hypotenuse). The unmeasured distance is equal to the measured distance plus d3. If d3 is positive, then the unmeasured distance is greater than the measured distance, and if d3 is negative, then the unmeasured distance is smaller than the measured distance.

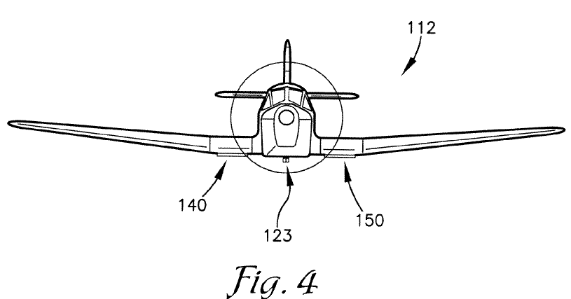

Referring also to FIG. 4, a second embodiment of the apparatus is shown which is particularly useful for airplanes with retractable landing gear. The second embodiment broadly comprises, in addition to some or all of the components and functionality described above and shown in FIGS. 1, 2, and 3, a third emitter/receiver device 123. The third emitter/receiver device 123 is positioned on an underside of the airplane 112 at a location such that when the landing gear 140,150 is raised (as shown in FIG. 4) the third emitter/receiver device 123 is lower than the first and second emitter/receiver devices and when the landing gear 140,150 is lowered the third emitter/receiver device 123 is higher than the first and second emitter/sensor devices. One possible location is on the airplane's belly midway between the first and second landing gear 140,150.

It will be appreciated by those with ordinary skill in the art that pilots sometimes forget to lower retractable landing gear, which can result in significant damage to the airplane when landing. By one estimate, such “gear-up” landings occur, on average, once per day. If this occurs while piloting an airplane equipped with this second embodiment of the present invention, then the microcontroller will report that the third emitter/receiver device 123 is the closest to the landing surface—which can only occur if the landing gear 140,150 has not been lowered—thereby providing a warning to the pilot to lower the landing gear 140,150.

In either the first or second embodiments, the sensor devices may be permanently or removably secured to the airplane, such as by quick-release connectors. Because the sensor devices may not be secured to the same point on the airplane each time they are installed, this embodiment may allow for quick and easy, e.g., “pushbutton”, distance calibration. This embodiment may be particularly useful for a pilot who frequently switches airplanes or for a pilot who plans to land under unknown or difficult conditions, e.g., at night, on an unfamiliar runway, or flying an unfamiliar airplane, and therefore desires the assistance provided by the present invention.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. An apparatus for determining and indicating a distance between a landing airplane and a landing surface, wherein the distance is no more than approximately twenty-five feet, the apparatus comprising:
a first device attached to a first side of the airplane and associated with a first landing wheel, the first device including a first emitter operable to emit a first signal toward the landing surface, and a first receiver operable to detect the first signal reflected by the landing surface;
a second device attached to a second side of the airplane and associated with a second landing wheel, the second device including a second emitter operable to emit a second signal toward the landing surface, and a second receiver operable to detect the second signal reflected by the landing surface;
one or more microcontrollers operable to determine a first distance between the first device and the landing surface based on a first time between emission and reception of the first signal, to determine a second distance between the second device and the landing surface based on a second time between emission and reception of the second signal, and to compare the first distance to the second distance to determine a shorter distance; and
a distance indicator operable to communicate the determined shorter distance to a pilot of the airplane.

2. The apparatus as set forth in claim 1, wherein each of the first and second devices are attached to a respective landing strut.

3. The apparatus as set forth in claim 1, wherein each of the first and second devices are attached to a respective wing.

4. The apparatus as set forth in claim 1, wherein the first device is removably attached to the first side of the airplane, and the second device is removably attached to the second side of the airplane.

5. The apparatus as set forth in claim 1, wherein the signals emitted by the first and second devices are of a type selected from the group consisting of: pulse radar, ultrasonic, infrared, and laser.

6. The apparatus as set forth in claim 1, wherein the distance indicator is operable to communicate the distance visually.

7. The apparatus as set forth in claim 1, wherein the distance indicator is operable to communicate the distance audibly.

8. The apparatus as set forth in claim 1, further including a flare indicator operable to indicate, based on the shorter distance, when the pilot should execute a flare maneuver.

9. The apparatus as set forth in claim 1, the one or more microcontrollers being further operable to, if the second device is inoperable, determine the second distance as a function of the first distance, a known spacing between the first and second devices, and a known angular orientation of the airplane.

10. The apparatus as set forth in claim 1, wherein the first and second landing wheels are moveable between a raised position and a lowered position, the apparatus further including
a third device attached to an underside of the airplane at a location such that when the first and second landing wheels are raised, the third device is lower than the first and second devices, and when the first and second landing wheels are lowered, the third device is higher than the first and second devices,
the third device including a third emitter operable to emit a third signal toward the landing surface, and a third receiver operable to detect the third signal reflected by the landing surface,
the one or more microcontrollers being operable to determine a third distance between the third device and the landing surface based on a third time between emission and reception of the third signal, and to compare the first, second, and third distances to determine the shorter distance, and
a landing gear indicator operable, when the third distance is the shorter distance, to alert the pilot that the first and second landing wheels are in the raised position.

11. A method for determining and indicating a distance between a landing airplane and a landing surface, wherein the distance is no more than approximately twenty-five feet, the method comprising the steps of
emitting a first signal from a first side of the airplane toward the landing surface, and receiving the first signal reflected by the landing surface;
emitting a second signal from a second side of the airplane toward the landing surface, and receiving the second signal reflected by the landing surface;
determining a first distance between the first side of the airplane and the landing surface based on a first time between emission and reception of the first signal;
determining a second distance between the second side of the airplane and the landing surface based on a second time between emission and reception of the second signal;
comparing the first distance and the second distance to determine a shorter distance; and
communicating the determined shorter distance to a pilot of the airplane.

12. The method as set forth in claim 11, further including the step of indicating, based on the shorter distance, when the pilot should perform a flare maneuver.
